(19) United States
(12) Patent Application Publication
(10) Pub. No.: US 2009/0006417 A1
(43) Pub. Date: Jan. 1, 2009

(54) Method and system of automatically selecting and playing online multimedia file

(75) Inventors: Cheng-Yue Chang, Yonghe City (TW); Chin-Fu Tsao, Sanchong City (TW)

Correspondence Address: BIRCH STEWART KOLASCH & BIRCH, PO BOX 747, FALLS CHURCH, VA, 22040-0747, US

(73) Assignee: Arcadyan Technology Corporation

(21) Appl. No.: 11/905,458

(22) Filed: Oct. 1, 2007

(30) Foreign Application Priority Data
Jun. 27, 2007 (TW) 096123371

(51) Int. Cl. G06F 17/30

(52) U.S. Cl. 707/10; 707/E17.001

(57) ABSTRACT

A method of automatically selecting and playing online multimedia files is applied to an online server and a multimedia player, which supports a plurality of multimedia playing formats and has a format auto-selecting module. The method includes the steps of: transmitting a multimedia data having a plurality of online playing formats to the multimedia player through a network by the online server; sorting the online playing formats and the multimedia playing formats according to a quality table to obtain a sorted table by the format auto-selecting module; and selecting and playing a multimedia file corresponding to one of the online playing formats in the sorted table from the online server by the multimedia player. A system of automatically selecting and playing online multimedia files is also disclosed.

### CROSS REFERENCE TO RELATED APPLICATIONS

This Non-provisional application claims priority under 35 U.S.C. §119(a) on Patent Application No(s). 096123371 filed in Taiwan, Republic of China on Jun. 27, 2007, the entire contents of which are hereby incorporated by reference.

### BACKGROUND OF THE INVENTION

1. Field of Invention

The invention relates to a method and a system of automatically selecting and playing online multimedia files.

2. Related Art

With the progress of the technology, various electronic products, especially a multimedia player such as a smart phone, a personal digital assistant (PDA) or an iPod, applied to the daily life have been developed rapidly. Thus, the human's life becomes more convenient and more colorful. These multimedia players can be used to play the multimedia files therein, and can download the multimedia files, such as a movie file or a music file, through the network and play the downloaded multimedia files.

As shown in FIG. 1, one end of the network INT is provided with an online server 11 set by a dealer, and the other end of the network INT is provided with a multimedia player 12 used by an end user. The online server 11 provides a lot of multimedia files, such as movie files, music files and the likes, to the user. The user can use the multimedia player 12, which may be connected to the network, to download the multimedia files from the online server 11 and then play the downloaded multimedia files.

When the user connects the multimedia player 12 to the network and downloads the multimedia files, such as a movie or a song, from the online server 11, the online server 11 also provides the playing formats supporting the multimedia files for the user to select the proper playing format. For example, the video-audio data may correspond to MPEG, AVI, WMV and RM files, and the music data may correspond to MP3 and WMA files. These playing formats actually correspond to different methods for compressing the multimedia files with different qualities and bitrates.

However, not all users have a predetermined level of understanding of these playing formats, so that some users may not make the best judgment and select the best playing format to play the downloaded multimedia files. In addition, the multimedia player 12 may not support all of the playing formats provided by the online server 11, thereby bringing the trouble to select the proper playing format for playing the downloaded multimedia file.

Thus, it is an important subject of the invention to provide a method and a system of automatically selecting and playing online multimedia files in order to help the user select the better or even the best playing format to play the downloaded multimedia files automatically, and thus to increase the efficiency in use and satisfy the requirement of the user.

### SUMMARY OF THE INVENTION

In view of the foregoing, the invention is to provide a method and a system of automatically selecting and playing online multimedia files capable of automatically helping a user select a better or even a best playing format for playing downloaded multimedia files.

To achieve the above, a method of automatically selecting and playing online multimedia files according to the invention is applied to an online server and a multimedia player. The multimedia player supports a plurality of multimedia playing formats and has a format auto-selecting module. The method includes the steps of: transmitting a multimedia data having a plurality of online playing formats to the multimedia player through a network by the online server; sorting the online playing formats and the multimedia playing formats according to a quality table by the format auto-selecting module to obtain a sorted table; and selecting and playing a multimedia file corresponding to one of the online playing formats in the sorted table by the multimedia player.

To achieve the above, the invention also discloses a system of automatically selecting and playing online multimedia files including an online server and a multimedia player. The online server transmits at least one multimedia data having a plurality of online playing formats to the multimedia player through a network. The multimedia player supports a plurality of multimedia playing formats and has a format auto-selecting module. The multimedia player receives the multimedia data through the network. Then, the format auto-selecting module sorts the online playing formats and the multimedia playing formats according to a quality table to obtain a sorted table. The multimedia player then selects and plays a multimedia file corresponding to one of the online playing formats in the sorted table from the online server.

As mentioned above, the method and system of automatically selecting and playing online multimedia files according to the invention sort the multimedia playing formats and the online playing formats according to the quality table by the format auto-selecting module so as to select the best online playing format (or multimedia playing format) automatically and than select and play the multimedia file corresponding to the best online playing format. Compared with the prior art, the user does not have to worry about selecting which one of the online playing formats (or the multimedia playing formats) for playing the multimedia file. Thus, the efficiency in use of the multimedia player may be enhanced, the user's requirement can be satisfied, the utility of the multimedia player can be significantly enhanced, and the product competition ability can be increased.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing a connection relationship between an online server and a multimedia player according to the prior art;

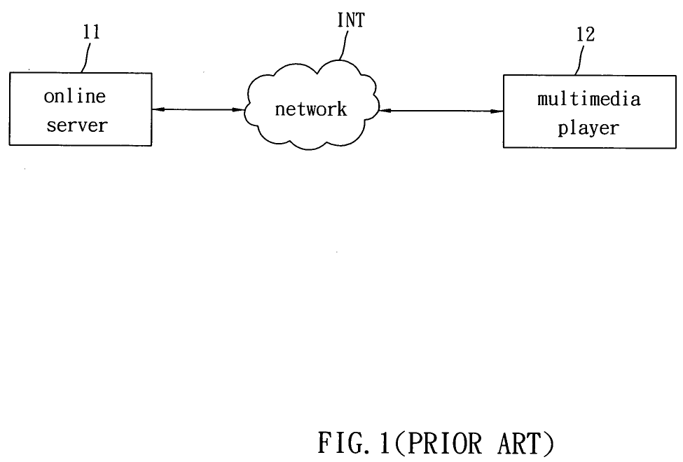

FIG. 2 is a schematic illustration showing a system of automatically selecting and playing online multimedia files according to a preferred embodiment of the invention; and

FIG. 3 is a flow chart showing a method of automatically selecting and playing online multimedia files according to the preferred embodiment of the invention.

### DETAILED DESCRIPTION OF THE INVENTION

The present invention will be apparent from the following detailed description, which proceeds with reference to the accompanying drawings, wherein the same references relate to the same elements.

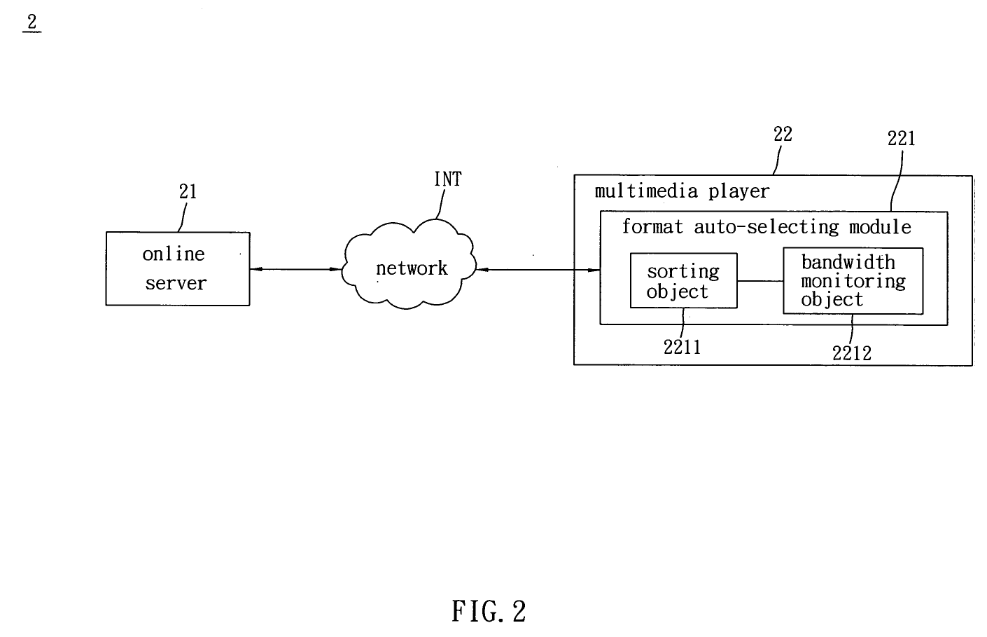

Referring to FIG. 2, a system 2 of automatically selecting and playing online multimedia files according to a preferred embodiment of the invention includes an online server 21, a network INT and a multimedia player 22. The online server 21 and the multimedia player 22 are connected to the network INT, respectively. In addition, the multimedia player 22 of this embodiment has a format auto-selecting module 221, which has a sorting object 2211 and a bandwidth monitoring object 2212.

In this embodiment, the online server 21 for providing multimedia files may be created by a dealer. The multimedia player 22, such as a personal digital assistant (PDA), a smart phone or an iPod, has the functions of playing the multimedia files and connecting to the network, and can support a plurality of multimedia playing formats. In addition, the network INT of this embodiment may include a wired network or a wireless network, or may include a combination of the wired network and the wireless network.

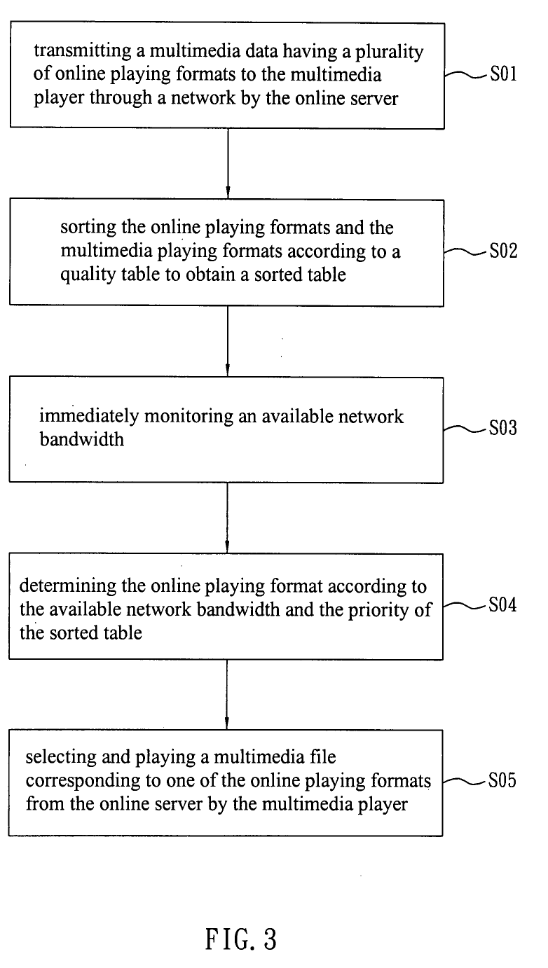

FIG. 3 shows a method of automatically selecting and playing online multimedia files applied to the online server 21 and the multimedia player 22 according to the preferred embodiment of the invention. The system 2 and the method of automatically selecting and playing online multimedia files according to the preferred embodiment of the invention will be described with reference to FIGS. 2 and 3.

First, the multimedia player 22 transmits a network request to the online server 21 to request for browsing the data content of the online server 21. Thereafter, the online server 21 responds a multimedia data to the multimedia player 22 through the network INT. Herein, the multimedia data may be a list of song information, which may include song names, singer names or album names. The multimedia player 22 receives the multimedia data transmitted by the online server 21 and displays the multimedia data on a screen so that the user may watch the multimedia data on the screen.

When the user decides to play one of the songs and selects the song, another request is transmitted to the online server 21 through the network INT. Then, the online server 21 transmits another multimedia data, which has a plurality of online playing formats, associated with the selected song to the multimedia player 22 through the network INT (step S01). In this embodiment, the online playing formats corresponding to the selected song. In other words, the selected song can be playing in accordance with anyone of the online playing formats.

After the multimedia player 22 receives the multimedia data having the online playing formats, the sorting object 2211 of the format auto-selecting module 221 sorts the online playing formats and the multimedia playing formats supported by the multimedia player 22 according to a quality table so as to obtain a sorted table (step S02). In this embodiment, the quality table is pre-built in the multimedia player 22 and sorts the playing,formats according to the playing qualities of various playing formats. In addition, the quality table in this embodiment may be updated through the network in order to involve the playing formats that appear later.

In this embodiment, the playing formats in the quality table may have two parameters, which are a coding-decoding format (Codec) and a bitrate. The playing formats may be (WMA, 192), (MP3, 192), (WMA, 128), (MP3, 128) and the like with the order of (WMA, 192)>(MP3, 192)>(WMA, 128)>(MP3, 128). That is, (WMA, 192) is better and (MP3, 128) is poorer. In addition, each of the multimedia playing formats and the online playing formats supported by the multimedia player 22 has the parameters including a coding-decoding format and a bitrate.

In addition, before the sorting object 2211 of the format auto-selecting module 221 sorts the online playing formats and the multimedia playing formats, the online playing formats and the multimedia playing formats will be intersected so that the online playing formats selected from the sorted table can be supported by the multimedia player 22.

After the sorting object 2211 finishes sorting and obtains the sorted table, the method of this embodiment further includes step S03 of immediately monitoring an available network bandwidth, and step S04 of determining one of the multimedia playing formats. Then, the multimedia player 22 selects a multimedia file corresponding to the determined multimedia playing format from the online server 21, and then plays the selected multimedia file (step S05). Accordingly, the user can enjoy the song that he or she selected.

To be noted, the network bandwidth of the network INT is not always constant because the network bandwidth may sometimes increase or decrease. The network bandwidth somewhat relates to the bitrate of the online playing formats (or the multimedia playing formats). If the bitrate of the selected online playing format is greater than the network bandwidth, the transmission lag problem may occur expectably so that the playing quality is deteriorated. Regarding to this problem, the bandwidth monitoring object 2212 of the format auto-selecting module 221 in this embodiment can immediately monitor the available network bandwidth. Then, the online playing format, according to which the multimedia player 22 plays the multimedia file, is determined in accordance with the network bandwidth monitored by the bandwidth monitoring object 2212. The rule is to select the online playing format having the bitrate smaller than the available network bandwidth monitored by the bandwidth monitoring object 2212 according to the priority of the sorted table. Thus, the multimedia player 22 can play the multimedia file according to the selected online playing format.

In summary, the method and system of automatically selecting and playing online multimedia files according to the invention sort the multimedia playing formats and the online playing formats according to the quality table by the format auto-selecting module so as to select the best online playing format (or multimedia playing format) automatically and than select and play the multimedia file corresponding to the best online playing format. Compared with the prior art, the user does not have to worry about selecting which one of the online playing formats (or the multimedia playing formats) for playing the multimedia file. Thus, the efficiency in use of the multimedia player may be enhanced, the user's requirement can be satisfied, the utility of the multimedia player can be significantly enhanced, and the product competition ability can be increased.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method of automatically selecting and playing online multimedia files, the method being applied to an online server and a multimedia player, the multimedia player supporting a plurality of multimedia playing formats and having a format auto-selecting module, the method comprising steps of:
transmitting a multimedia data having a plurality of online playing formats to the multimedia player through a network by the online server;
sorting the online playing formats and the multimedia playing formats according to a quality table to obtain a sorted table by the format auto-selecting module; and
selecting and playing a multimedia file corresponding to one of the online playing formats in the sorted table from the online server by the multimedia player.

2. The method according to claim 1, further comprising a step of:
intersecting the online playing formats and the multimedia playing formats by the format auto-selecting module.

3. The method according to claim 1, wherein the quality table records a plurality of playing formats arranged according to playing qualities.

4. The method according to claim 3, wherein each of the playing formats has a coding-decoding format and a bitrate.

5. The method according to claim 1, wherein each of the multimedia playing formats has a coding-decoding format and a bitrate.

6. The method according to claim 1, wherein each of the online playing formats has a coding-decoding format and a bitrate.

7. The method according to claim 5, further comprising a step of:
immediately monitoring an available network bandwidth by a bandwidth monitoring object of the format auto-selecting module.

8. The method according to claim 7, further comprising a step of:
determining the multimedia playing format for the multimedia player to select and play the multimedia file according to the network bandwidth monitored by the bandwidth monitoring object.

9. The method according to claim 8, further comprising a step of:
selecting the online playing format having the bitrate smaller than the network bandwidth monitored by the bandwidth monitoring object according to a priority of the sorted table, and thus playing the multimedia file.

10. The method according to claim 1, wherein the network comprises a wired network or a wireless network.

11. A system of automatically selecting and playing online multimedia files, comprising:
an online server for transmitting a multimedia data having a plurality of online playing formats through a network; and
a multimedia player supporting a plurality of multimedia playing formats, wherein the multimedia player has a format auto-selecting module, and receives the multimedia data through the network, the format auto-selecting module sorts the online playing formats and the multimedia playing formats according to a quality table to obtain a sorted table, and the multimedia player selects and plays a multimedia file corresponding to one of the online playing formats in the sorted table from the online server.

12. The system according to claim 11, wherein the format auto-selecting module sorts an intersection of the online playing formats and the multimedia playing formats and thus obtains the sorted table.

13. The system according to claim 11, wherein the quality table records a plurality of playing formats arranged according to playing qualities.

14. The system according to claim 13, wherein each of the playing formats has a coding-decoding format and a bitrate.

15. The system according to claim 11, wherein each of the multimedia playing formats has a coding-decoding format and a bitrate.

16. The system according to claim 11, wherein each of the online playing formats has a coding-decoding format and a bitrate.

17. The system according to claim 15, wherein the format auto-selecting module has a bandwidth monitoring object for immediately monitoring an available network bandwidth.

18. The system according to claim 17, wherein the bandwidth monitoring object determines the multimedia playing format for the multimedia player to play the multimedia file according to the network bandwidth monitored.

19. The system according to claim 18, wherein the bitrate of the selected online playing format is smaller than the network bandwidth monitored by the bandwidth monitoring object.

20. The system according to claim 11, wherein the network comprises a wired network or a wireless network.
